(19) United States
(12) Patent Application Publication
(10) Pub. No.: US 2009/0277767 A1
(43) Pub. Date: Nov. 12, 2009

(54) KEYPAD ASSEMBLY

(75) Inventors: CHIH-WEI CHENG, Tu-Cheng (TW); CHIA-HSIN CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/334,647

(22) Filed: Dec. 15, 2008

(30) Foreign Application Priority Data
May 9, 2008 (CN) 200810301519.8

(51) Int. Cl. H01H 1/10

(52) U.S. Cl. 200/512

(57) ABSTRACT

A keypad assembly (10) is described. The keypad assembly (10) includes a press layer (11) made of transparent material and a pattern layer (12) arranged under the transparent press layer (11). The transparent press layer (11) forms a plurality of buttons (111). The pattern layer (12) is aligned with and attached to the transparent press layer (11). The pattern layer (12) is made of translucent material. An ink is screen-printed to the pattern layer (12) to form keypad numerals/symbols (123).

### BACKGROUND

1. Field of the Invention

The present invention relates to keypad assemblies and, particularly, to a film keypad assembly.

2. Description of Related Art

With the ongoing development of technologies, keypad assemblies used in portable electronic devices (e.g., mobile phones) are becoming smaller and thinner.

A typical film keypad assembly includes a transparent press layer for contact with user's fingers and a transparent pattern layer with Keypad numerals/symbols (e.g., 1 or #). The transparent press layer and the transparent pattern layer are aligned with and integrally adhered to each other, thus the keypad numerals/symbols can be visible through the transparent press layer.

Because neither of the transparent press layer and the transparent pattern layer can effectively prevent internal electronic components within portable electronic devices from visibility, a translucent inking step is typically required to screen-print on the transparent pattern layer to prevent internal electronic components from being visible through the film keypad assembly. However, the above-described manufacturing process is costly and complex.

Therefore, there is room for improvement within the art.

### BRIEF DESCRIPTION OF THE DRAWINGS

Many aspects of a keypad assembly can be better understood with reference to the following drawings. These drawings are not necessarily drawn to scale, the emphasis instead being placed upon clearly illustrating the principles of the present keypad assembly. Moreover, in the drawings like reference numerals designate corresponding sections throughout the several views.

FIG. 1 is an exploded, isometric view of a keypad assembly, according to an exemplary embodiment.

FIG. 2 is another exploded, isometric view of the keypad assembly shown in FIG. 1.

FIG. 3 is an assembled view of the keypad assembly shown in FIG. 1.

### DETAILED DESCRIPTION OF EXEMPLARY EMBODIMENT

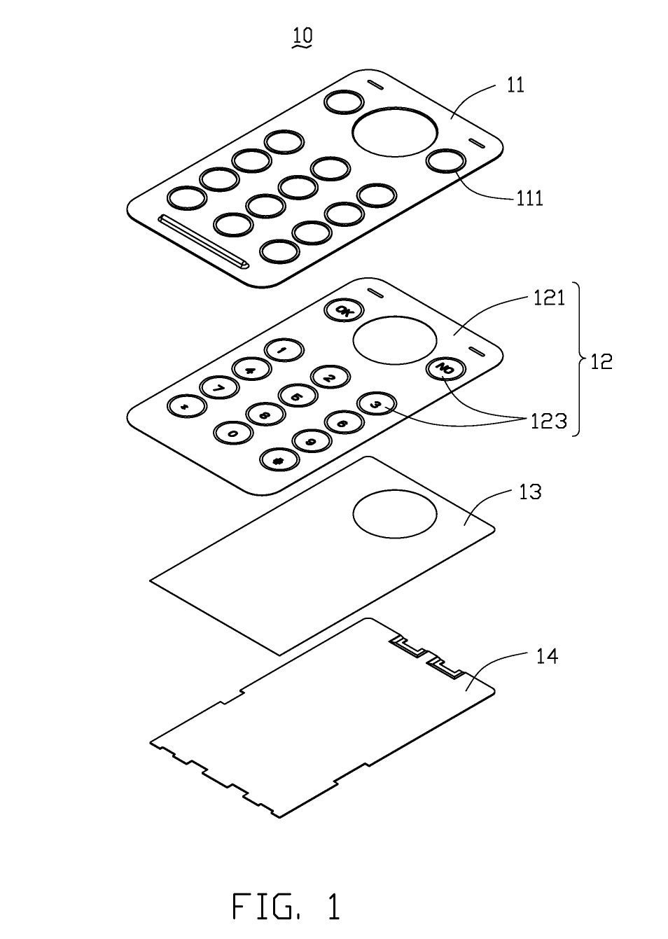

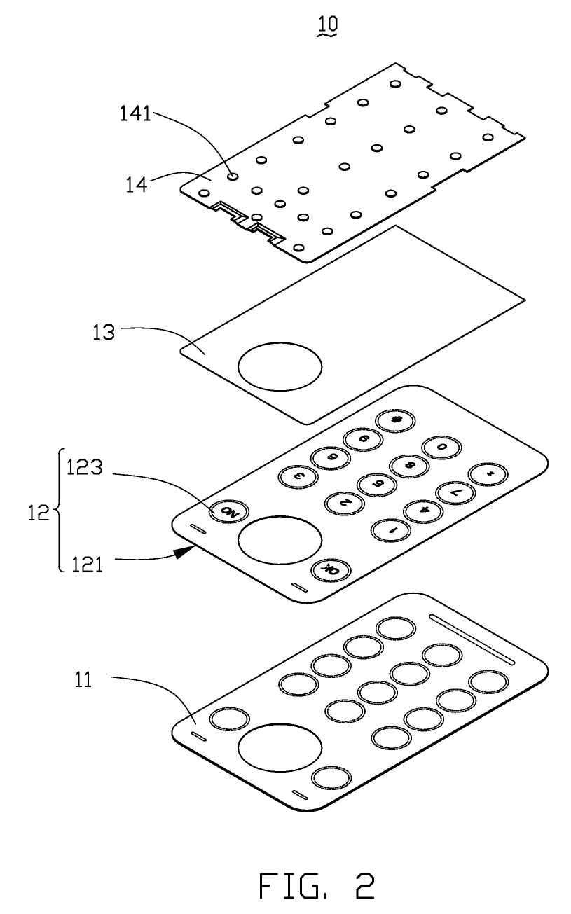

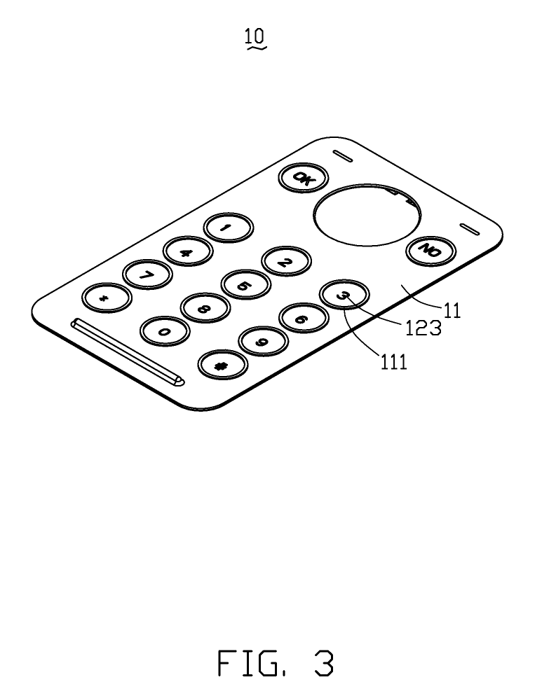

FIGS. 1 through 3 show an exemplary keypad assembly 10. The keypad assembly 10 includes a transparent press layer 11, a generally translucent pattern layer 12, an adhesive layer 13 and a resilient layer 14.

The transparent press layer 11 is made of transparent material (e.g., thermoplastic polyurethane). The transparent press layer 11 is a thin sheet, forming a plurality of buttons 111 on one side facing away from the pattern layer 12.

The pattern layer 12 is also a thin sheet and arranged under the transparent press layer 11. The pattern layer 12 is made of translucent materials, such as a mixture of acrylonitrile butadiene styrene (ABS) and polycarbonate (PC). An ink is screen-printed on a side of the pattern layer 12 facing the transparent press layer 11 to form keypad numerals/symbols 123.

The adhesive layer 13 is a double-sided adhesive and adheres the resilient layer 14 to the pattern layer 12.

A plurality of protrusions 141 protrude from the side of the resilient layer 14 away from the pattern layer 12, and are used to contact electrical contact points of a printed circuit board (not shown).

In assembly, the transparent press layer 11, the pattern layer 12 and the resilient layer 14 are aligned with and serially attached (e.g., coated) to each other to form a unitary element.

The generally translucent pattern layer 12 can prevent internal electronic components within portable electronic devices from being visible through the keypad assembly 10 instead of another translucent ink requiring an additional and separate inking step.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of sections within the principles of the invention to the full extent indicated by the broad general meaning of the terms, in which the appended claims are expressed.

What is claimed is:

1. A keypad assembly, comprising:
a transparent press layer forming a plurality of buttons; and
a generally translucent pattern layer arranged under the transparent press layer, the pattern layer being aligned with and attached to the transparent press layer, an ink being screen-printed on the side of the pattern layer facing the transparent press layer to form keypad numerals or symbols.

2. The keypad assembly as claimed in claim 1, wherein the pattern layer is made of a translucent material.

3. The keypad assembly as claimed in claim 2, wherein the translucent material is a mixture of acrylonitrile butadiene styrene and polycarbonate.

4. The keypad assembly as claimed in claim 1, further including a resilient layer, wherein the resilient layer is aligned with and adhered to the pattern layer.

5. The keypad assembly as claimed in claim 3, wherein a plurality of protrusions protrude from the resilient layer.
